(19) United States
(12) Patent Application Publication
(10) Pub. No.: US 2024/0278629 A1
(43) Pub. Date: Aug. 22, 2024

(54) Car cover with special clamping handles

(71) Applicant: ZHEJIANG SURPASS AUTO PARTS CO.,LTD., Wenzhou City (CN)

(72) Inventors: Chengqiang Liu, Wenzhou City (CN); Hongyan Ge, Wenzhou City (CN); Yi Lin, Wenzhou City (CN); Lei Lin, Wenzhou City (CN)

(21) Appl. No.: 18/177,225

(22) Filed: Mar. 2, 2023

(30) Foreign Application Priority Data
Feb. 17, 2023 (CN) 202310155386.2

(51) Int. Cl. B60J 7/14; B60J 7/19

(52) U.S. Cl. CPC B60J 7/141; B60J 7/198

(57) ABSTRACT

The present invention discloses a special handle clamping cover including a fixed plate and at least one rotating plate, the rotating plate is connected to a handle system, the handle system includes a handle groove, a handle, a handle slider, a handle rotating T-rod and a handle inclined mount, the handle groove is connected to the rotating plate, the handle groove is provided with a handle avoidance opening on side wall, the handle slider is slidingly connected to the handle groove, the handle is connected to a handle rotating T-rod, the handle rotating T-rod is hinged to the handle slider, the handle inclined mount is provided in correspondence with the handle avoidance opening, the handle inclined mount is used to clamp the handle. By providing a handle avoidance opening and a handle inclined mount in the handle groove, and hinging the handle rotating T-rod to the handle slider, when the handle slider is locked to the car cover, the handle can be tilted at a certain angle to extend out of the handle avoidance opening and snap with the handle inclined mount to lock the handle and prevent the handle from opening suddenly.

### TECHNICAL FIELD

This invention is relevant to automobile accessories, especially a folding car cover with special clamping handles.

### BACKGROUND TECHNOLOGY

The cargo hopper of a pick-up truck (also known as a sedan truck) is used to carry goods, as long as it is open, in order to avoid the rain from wetting the goods inside the cargo hopper in rainy and snowy weather, a car cover is invented and installed on the cargo hopper of the pick-up truck, using the car cover to shelter the goods in the cargo hopper to avoid the goods inside from being wet by rain.

If the vehicle encounters bumps in the process of driving, the locking structure of the existing cover may pop open and make the cover open, affecting the safety of driving; secondly, the car cover is waterproofed by adhesive strips, which become less effective after prolonged use.

### ABOUT THE INVENTION

The purpose of the invention is to enable the handle to be tightened after the car cover has been locked in place by a handle structure that prevents the car cover from opening due to bumps in traffic.

In order to solve the above problems of the existing technology, the technical solution adopted in the invention is as follows.

A car cover with special clamping handles includes a fixed plate and at least one rotating plate, the rotating plate is connected to a handle system, the handle system includes a handle groove, a handle, a handle slider, a handle rotating T-rod and a handle inclined mount.

The handle groove is connected to the rotating plate, the handle groove is provided with a handle avoidance opening on the side wall.

The handle slider is slidingly connected to the handle groove.

The handle is connected to a handle rotating T-rod, the handle rotating T-rod is hinged to the handle slider.

The handle inclined mount is provided in correspondence with the handle avoidance opening, the handle inclined mount is used to snap the handle in place.

By providing a handle avoidance opening and a handle inclined mount in the handle groove, and hinging the handle rotating T-rod to the handle slider, when the handle slider is locked to the car cover, the handle can be tilted at a certain angle to extend out of the handle avoidance opening and snap into the handle inclined mount to lock the handle and prevent it from suddenly opening.

The handle inclined mount is set in correspondence with the handle avoidance opening so that when the handle slider is locked, the handle can be extended from the handle avoidance opening and snap into the handle inclined mount.

Further, the handle rotating T-rod is connected with a movable ring, the handle slider is connected with a fixed ring, the movable ring and the fixed ring are socketed to each other, in that the handle rotating T-rod and the handle slider are connected with the movable ring and the fixed ring respectively, the movable ring and the fixed ring are socketed to form an articulated structure to facilitate the rotation of the handle, the handle inclined mount is connected to the rotating plate or the handle groove, the specific connection position of the handle inclined mount can be changed and the structure is various as long as the handle can be snapped to limit the position of the handle, the handle slider is provided with a slider connector, the fixed ring is connected to the slider connector.

Further, the handle groove is fixedly connected to a limit block, the limit block is used to limit the handle slider, the limit block is provided on the side of the handle avoidance opening away from the handle slider. By providing the limit block, the sliding distance of the handle slider can be limited to prevent the handle slider from sliding inside the handle groove.

Further, the fixed plate and the rotating plate as well as the rotating plate and the rotating plate are connected by a rotating shaft system, the rotating shaft system includes a left connector, a right connector and an intermediate bar, the left connector and the right connector are respectively provided at the two ends of the intermediate bar, the left connector and the right connector are respectively rotated in relation to the intermediate bar. By providing the rotating shaft system, the plate can be rotated relative to each other to realize the opening and closing of the car cover. The intermediate bar is provided with a rotating recess at each end, the left connector includes a clamping portion and a sleeve, the sleeve is located in one of the rotating recesses; the right connector is a mirror reflection of the left connector, the sleeve of the right connector is located in the other rotating recess. The clamping part is used to connect the plate body.

Further, it includes a left joint, a right joint and an intermediate joint, the left joint includes a joint insertion port, the joint insertion port and the left connector are plugged in, the right joint includes a joint insertion port, the joint insertion port and the right connector are plugged in, the intermediate joint and the intermediate bar are plugged in, the intermediate joint is provided with two joint spindles, each joint spindle is provided with a joint drainage groove on the lower side, the joint spindles extending into the sleeve, the left joint and the right joint are in a mirror symmetric structure, the left joint is connected to the left connector, the right joint is connected to the right connector. By setting the joint spindle in the intermediate joint, the joint spindle is inserted into the sleeve during installation, while the intermediate joint snaps into place with the intermediate bar, the left and right connectors are connected to the intermediate bar through the intermediate joint.

The beneficial effects of the invention are as follows.

1. By setting a handle avoidance opening and a handle inclined mount in the handle groove and hinging the handle rotating T-rod to the handle slider, when the handle slider is locked to the car cover, the handle can be tilted at a certain angle to extend out of the handle avoidance opening and snap with the handle inclined mount to lock the handle and prevent the handle from opening suddenly.

2. By setting a drainage groove in the intermediate member insert, the rainwater entering the rotating shaft system can be eliminated in time, thus playing a good waterproof effect.

### DESCRIPTION OF DRAWINGS

FIG. 1 is the structure schematic diagram 1 of the car cover of the invention.

FIG. 2 is the structure schematic diagram 2 of the car cover of the invention.

FIG. 3 is the partial enlarged view of part A in FIG. 2.

FIG. 4 is the partial enlarged view of part B in FIG. 2.

FIG. 5 is the structure schematic diagram of the cover plate.

FIG. 6 is the partial enlarged view of part C in FIG. 5.

FIG. 7 is the structure schematic diagram 2 of the car cover of the invention.

FIG. 8 is the partial enlarged view 1 of part D in FIG. 7.

FIG. 9 is the partial enlarged view 2 of part D in FIG. 7.

FIG. 10 is the structure schematic diagram 4 of the car cover of the invention.

FIG. 11 is the partial enlarged view of part E in FIG. 10.

FIG. 12 is the partial enlarged view of part F in FIG. 10.

In the picture: 1—Handle system; 11—Handle groove; 1101—Handle avoidance opening; 12—Handle; 13—Handle slider; 14—Handle rotating T-rod; 1401—Slider connector; 1402—Movable ring; 1403—Fixed ring; 15—Handle inclined mount; 151—First lug; 152—Second lug; 2—Rotating shaft system; 21—Left connector; 2101—Shaft sleeve; 22—Intermediate bar; 2201—Rotating recess; 23—Right connector; 24—Left joint; 2401—Joint insertion port; 25—Intermediate joint; 2501—Joint spindle; 2502—Joint drainage groove; 26—Right joint; 27—Waterproof rubber strip.

### The Concrete Method to Carry Out

The following instruction further explains the invention's concrete implementation method.

In order to enable a clearer understanding of the objects mentioned above, features and advantages of the present invention, the invention is described in detail below in connection with the accompanying drawings and specific embodiments. It should be noted that the embodiments of the present application and the features in the embodiments can be combined without conflict.

The terms “first”, “second”, “third”, etc. are only used to differentiate the description and should not be construed as indicating or implying relative importance.

In the description of the invention, it should also be noted that, unless otherwise expressly specified and limited, the terms “arranged,” “installed,” “connected,” and “combined” should be understood in a broad sense. for example, it may be a fixing connection, it can also be a detachable connection or an integral connection. it can be a mechanical connection or an electrical connection. it can be a direct connection or an indirect connection through an intermediate media, and it can be internal connection within two assemblies. For those of ordinary skill in this field, specific meanings of the above terms in the present invention can be understood in specific situations.

The specific embodiments of the present invention will be described in detail below in connection with the accompanying drawings. It should be understood that the specific embodiments described herein are intended only to illustrate and explain the present invention and not to limit it.

### EMBODIMENT 1

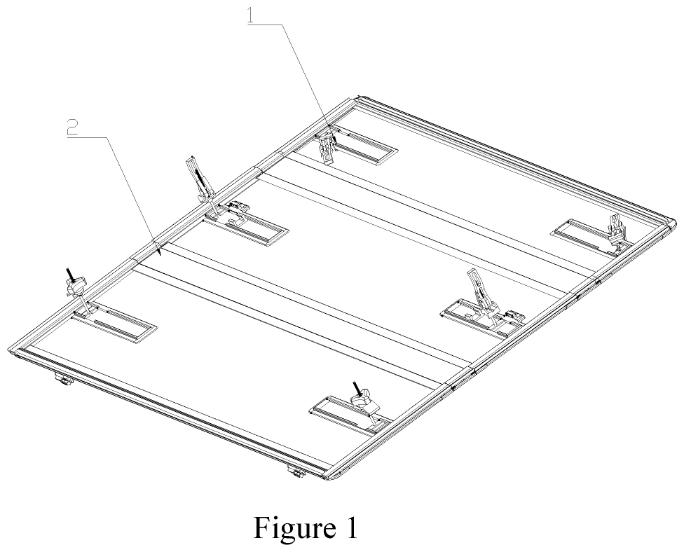

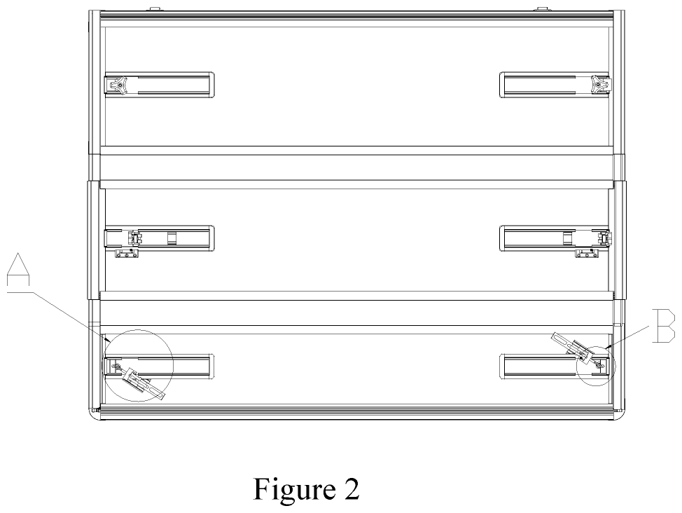

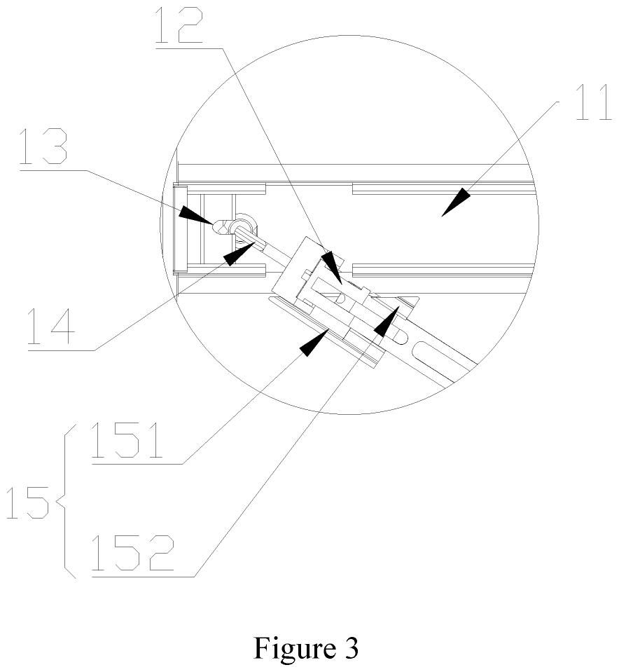

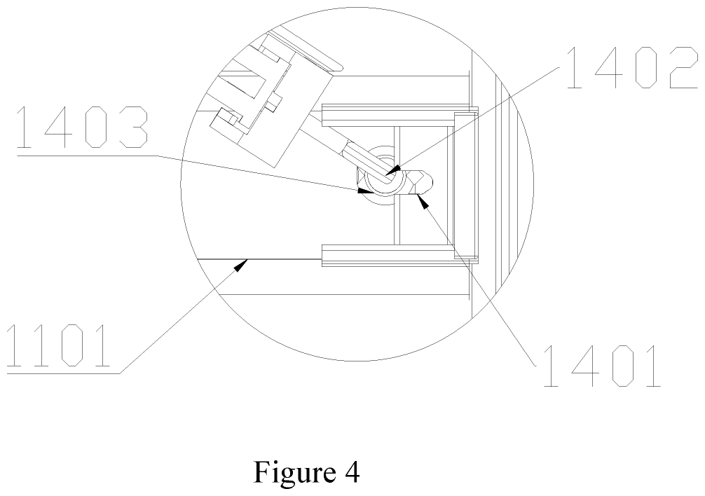

As shown in FIGS. 1 to 4, a car cover with special clamping handles includes a fixed plate and at least one rotating plate, the rotating plate is connected to a handle system 1, the handle system 1 includes a handle groove 11, a handle 12, a handle slider 13, a handle rotating T-rod 14 and a handle inclined mount 15.

The handle groove 11 is connected to the rotating plate, the handle groove 11 is provided with a handle avoidance opening 1101 on the side wall.

The handle slider 13 is slidingly connected to the handle groove 11.

The handle 12 is connected to a handle rotating T-rod 14, the handle rotating T-rod 14 is hinged to the handle slider 13.

The handle inclined mount 15 is provided in correspondence with the handle avoidance opening 1101, the handle inclined mount 15 is used to snap the handle 12 in place.

By providing a handle avoidance opening 1101 and a handle inclined mount 15 in the handle groove 11 and hinging the handle rotating T-rod 14 to the handle slider 13, when the handle slider 13 is locked to the car cover, the handle 12 can be tilted at an angle to extend out of the handle avoidance opening 1101 and snap into the handle inclined mount 15 to lock the handle 12 and prevent it from suddenly opening.

The handle inclined mount 15 is set in correspondence with the handle avoidance opening 1101 so that when the handle slider 13 is locked, the handle can be extended out of the handle avoidance opening 1101 and snap into the handle inclined mount 15.

### EMBODIMENT 2

On the basis of embodiment 1, the handle rotating T-rod 14 is connected with a movable ring 1402, the handle slider 13 is connected with a fixed ring 1403, the movable ring 1402 and the fixed ring 1403 are socketed to each other.

Here the movable ring 1402 and the fixed ring 1403 are relative, as the handle slider 13 simply slides along the handle groove 11, while the handle rotating T-rod 14 needs to be rotated, so that the fixed ring 1403 is connected to the handle slider 13 and the movable ring 1402 is connected to the handle rotating T-rod 14.

The handle rotating T-rod 14 and the handle slider 13 are connected with the movable ring 1402 and the fixed ring 1403 respectively, and the movable ring 1402 and the fixed ring 1403 are socketed to form an articulated structure to facilitate the rotation of the handle 12.

The handle inclined mount 15 is connected to the rotating plate or the handle groove 11.

The centre line of the handle inclined mount 15 is at an angle of 30°-60° to the centre line of the handle groove, the handle inclined mount 15 includes a first lug 151 and a second lug 152, the first lug 151 and the second lug 152 are used to snap the handle 12 into place.

The specific connection position of the handle inclined mount 15 can be changed and the structure of the handle inclined mount 15 is various as long as the handle can be snapped to limit the position of the handle 12.

The handle slider 13 is provided with a slider connector 1401, the fixed ring 1403 is connected to the slider connector 1401.

The handle groove 11 is fixedly connected to a limit block (not shown in the figure), the limit block is used to limit the handle slider 13.

The limit block is provided on the side of the handle avoidance opening 1101 away from the handle slider 13, by providing the limit block the sliding distance of the handle slider 13 can be limited to prevent the handle slider 13 from sliding inside of the handle groove 11 (here the inside is the end of the handle groove 11 away from the edge of the car cover)

### EMBODIMENT 3

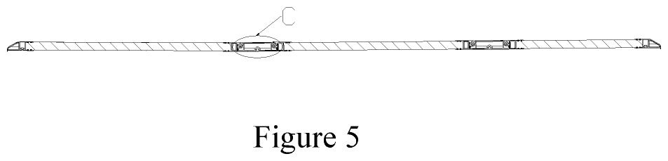

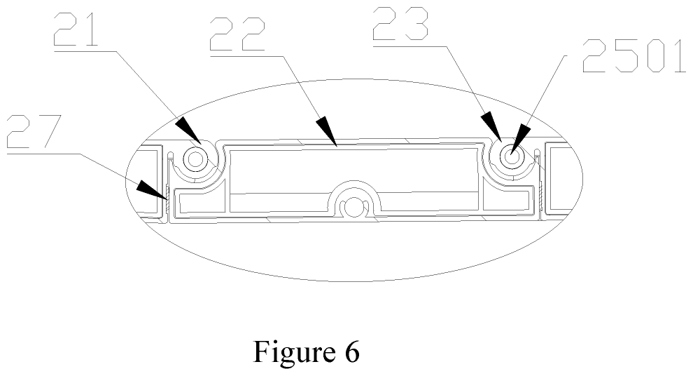

On the basis of embodiment 2, as shown in FIGS. 5 and 6, the fixed plate and the rotating plate as well as the rotating plate and the rotating plate are connected by a rotating shaft system 2.

The rotating shaft system 2 includes a left connector 21, a right connector 23 and an intermediate bar 22, the left connector 21 and the right connector 23 are respectively provided at the two ends of the intermediate bar 22, the left connector 21 and the right connector 23 are respectively rotated in relation to the intermediate bar 23.

By providing the rotating shaft system 2, so that the plate can be rotated relative to each other to realize the opening and closing of the car cover.

The intermediate bar 22 is provided with a rotating recess 2201 at each end.

The left connector 21 includes a clamping portion and a sleeve 2101, the sleeve 2101 is located in one of the rotating recesses 2201; the right connector 23 is a mirror reflection of the left connector 21, the sleeve 2101 of the right connector 23 is located in the other rotating recess 2201. The clamping part is used to connect the cover plate.

The connectors (left connector 21 and right connector 23) are not directly connected to the intermediate bar 22, but set the sleeve 2101 in the rotating recess 2201, so that the sleeve 2101 can be rotated with respect to the rotating recess 2201.

The connector is able to rotate 90° relative to the intermediate bar 22, which enables 180º rotation of the cover plate and folding of the cover plate through the connection of the left connector 21 and the right connector 23 to the intermediate bar 22.

Both the left connector 21 and the right connector 23 are connected to a watertight rubber strip 27 on the side near the intermediate bar 22. When closing the car cover, the intermediate bar 22 squeezes the waterproof rubber strip 27 on both sides to achieve a waterproof effect.

### EMBODIMENT 4

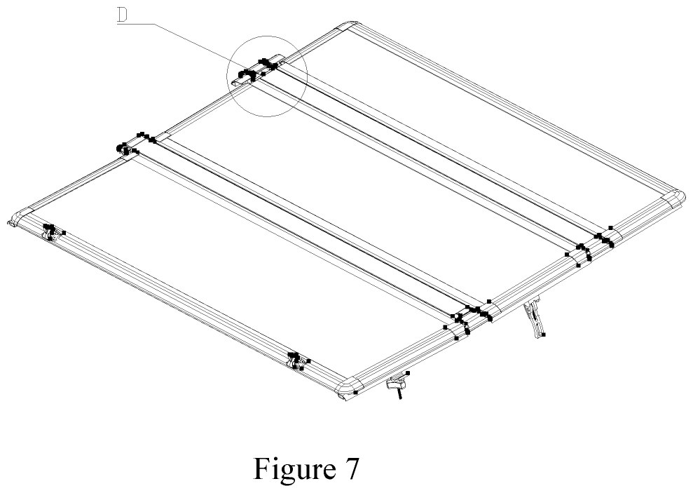

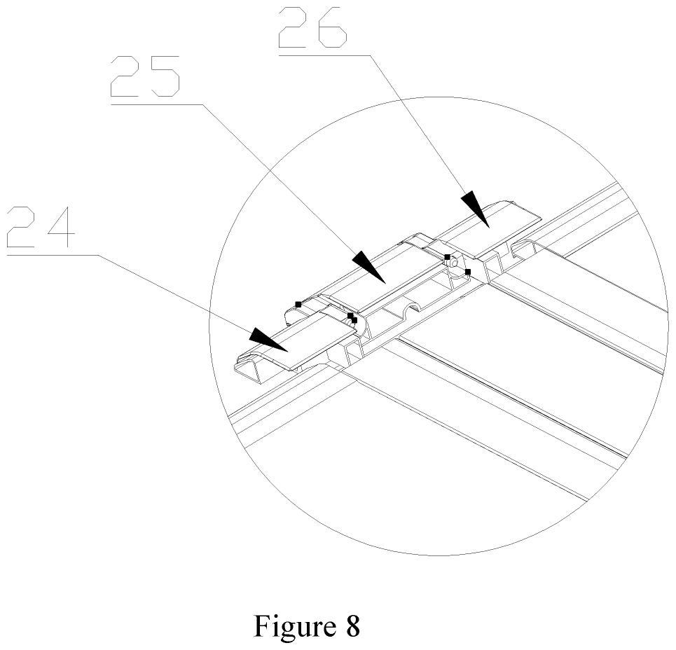

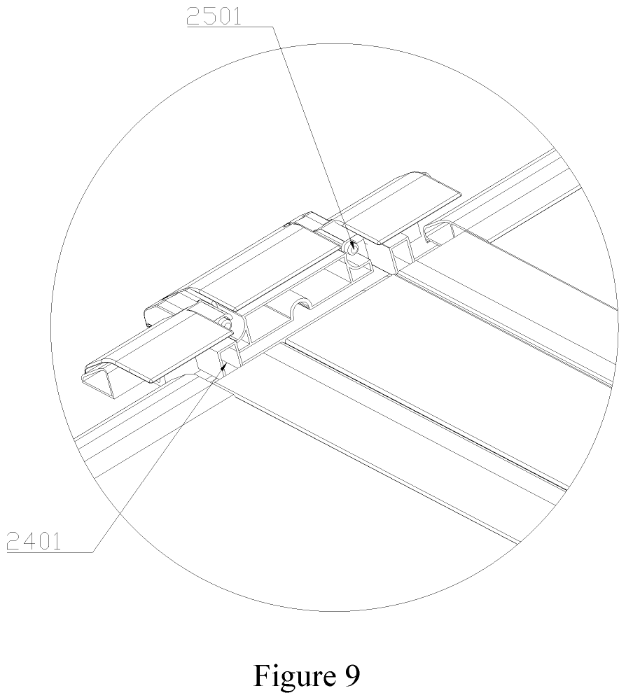

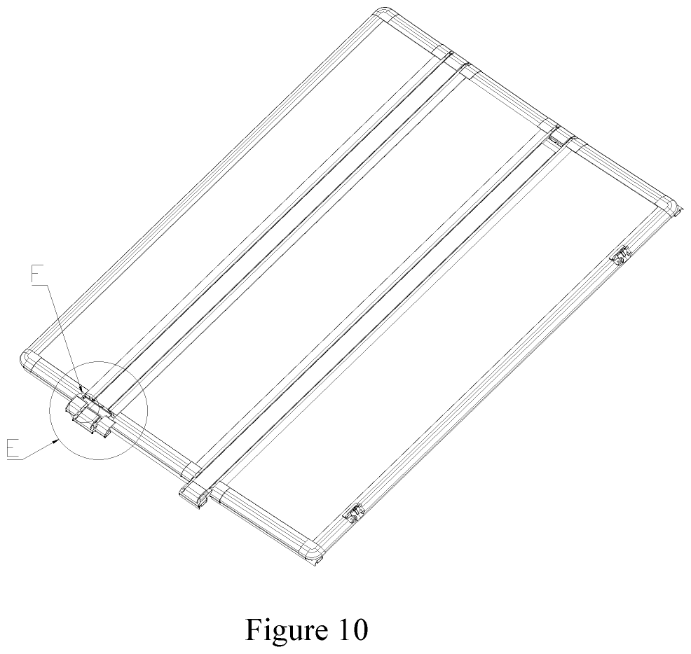

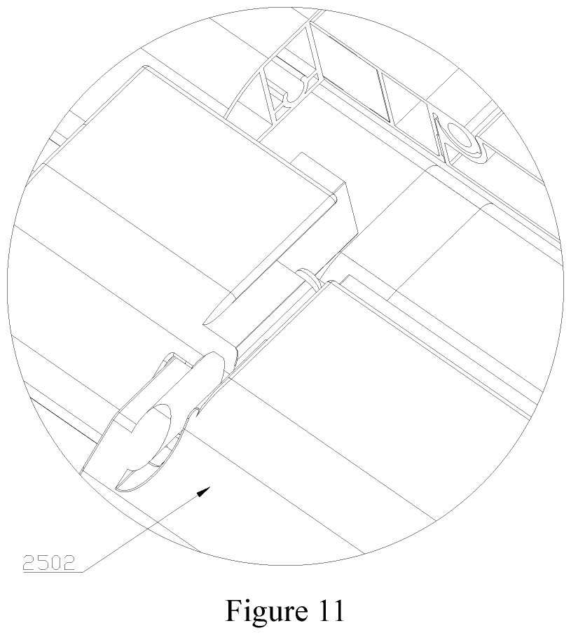

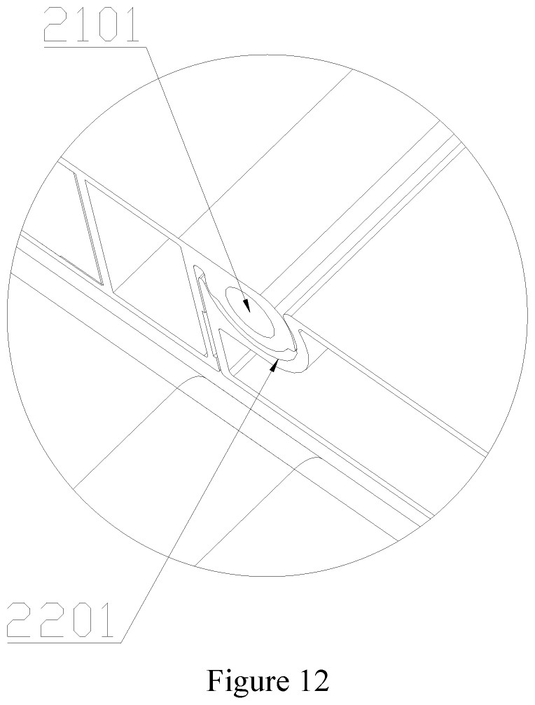

On the basis of embodiment 3, as shown in FIGS. 7 to 12, it further includes a left joint 24, a right joint 26 and an intermediate joint 25.

The left joint 24 as mentioned includes a joint insertion port 2401, said joint insertion port 2401 and the left connector 21 are plugged in.

The right connector 26 includes a connector insertion port 2401, the connector insertion port 2401 and the right connector 23 are plugged in.

The intermediate joint 25 and the intermediate member 22 are plugged in, the intermediate joint 25 is provided with two joint spindles 2501, each joint spindle 2501 is provided with a joint drainage groove 2502 on the lower side, the joint spindles 2501 are extended into the sleeve 2101. The left joint 24 and the right joint 26 are in mirror symmetric structure, the left connector 24 is connected to the left connector 21 and the right connector 26 is connected to the right connector 23.

By setting the joint spindle 2501 in the intermediate joint 25, the joint spindle 2501 is inserted into the sleeve 2101 during installation, while the intermediate joint 25 snaps into the intermediate bar 22, the left connector 21 and the right connector 23 are connected to the intermediate bar 22 through the intermediate joint 25.

After connection, there will be a gap between the sleeve 2101 and the rotating recess 2201, when it rains, rainwater will enter the rotating recess 2201 through this gap, then flow to the joint drainage groove 2502, and finally flow out along the joint drainage groove 2502, playing a good rainproof effect.

The invention is not limited to the above-mentioned optional embodiments, anyone can come up with various other forms of products under the inspiration of the invention, however, regardless of any changes in its shape or structure, all technical solutions that fall within the scope defined by the claims of the present invention shall fall within the scope of protection of the invention.

1. A car cover with special clamping handles, wherein, it includes a fixed plate and at least one rotating plate, the rotating plate is connected to a handle system (1), the handle system (1) includes a handle groove (11), a handle (12), a handle slider (13), a handle rotating T-rod (14) and a handle inclined mount (15).
The handle groove (11) is connected to the rotating plate, the handle groove (11) is provided with a handle avoidance opening (1101) on the side wall.
The handle slider (13) is slidingly connected to the handle groove (11).
The handle (12) is connected to a handle rotating T-rod (14), the handle rotating T-rod (14) is hinged to the handle slider (13).
The handle inclined mount (15) is provided in correspondence with the handle avoidance opening (1101), the handle inclined mount (15) is used to snap the handle (12) in place.

2. A car cover with special clamping handles according to claim 1, wherein, the handle rotating T-rod (14) is connected with a movable ring (1402), the handle slider (13) is connected with a fixed ring (1403), the movable ring (1402) and fixed ring (1403) are socketed to each other.

3. A car cover with special clamping handles according to claim 1, wherein, the handle inclined mount (15) is connected to a rotating plate or handle groove (11).

4. A car cover with special clamping handles according to claim 1, wherein, the center line of the handle inclined mount (15) is at an angle of 30°-60° to the center line of the handle groove (11), the handle inclined mount (15) includes a first lug (151) and a second lug (152), the first lug (151) and second lug (152) are used for snapping against the handle (12).

5. A car cover with special clamping handles according to claim 1, wherein, the fixed plate and the rotating plate as well as the rotating plate and the rotating plate are connected by a rotating shaft system (2), the rotating shaft system (2) includes a left connector (21), a right connector (23) and an intermediate bar (22).
The left connector (21) and right connector (23) are respectively provided at the two ends of the intermediate bar (22), the left connector (21) and the right connector (23) are respectively rotated in relation to the intermediate bar (22).

6. A car cover with special clamping handles according to claim 5, wherein, the left connector (21) includes a clamping portion and a sleeve (2101), the sleeve (2101) is located in one of the rotating recesses (2201).
The right connector (23) includes a clamping portion and a sleeve (2101), the sleeve (2101) of the right connector (23) is located in the other rotating recess (2201).

7. A car cover with special clamping handles according to claim 5, wherein, it further includes a left joint (24), a right joint (26) and an intermediate joint (25).
The left joint (24) includes a joint insertion port (2401), the joint insertion port (2401) and the left connector (21) are plugged in.
The right joint (26) includes a joint insertion port (2401), the joint insertion port (2401) and the right connector (23) are plugged in.
The intermediate joint (25) and the intermediate bar (22) are plugged in, the intermediate joint (25) being provided with two joint spindles (2501), each joint spindle (2501) is provided with a joint drainage groove (2502) on the lower side, the joint spindles (2501) extending into the sleeve (2101).

8. A car cover with special clamping handles according to claim 1, wherein, the handle slider (13) is provided with a slider connector (1401), the fixed ring (1403) is connected to the slider connector (1401).

9. A car cover with special clamping handles according to claim 1, wherein, the handle groove (11) is fixedly connected to a limiting block, the limiting block is used to limit the handle slider (13).

10. A car cover with special clamping handles according to claim 1, wherein, both the left connector (21) and the right connector (23) are connected with a waterproof rubber strip (27) on the side near the intermediate bar (22).
